(19) United States
(12) Patent Application Publication
(10) Pub. No.: US 2006/0181988 A1
(43) Pub. Date: Aug. 17, 2006

(54) Method and apparatus for determining the optimal write power and optical recording medium for use by such method and apparatus

(75) Inventors: Johannes Hendrikus Maria Spruit, Eindhoven (NL); Benno Tieke, Eindhoven (NL)

Correspondence Address: Corporate Patent Counsel;Philip Electronics North America Corporation, P.O. Box 3001, Briarcliff Manor, NY, 10510, US

(73) Assignee: Koninklijke Philips Electronics N.V.

(21) Appl. No.: 10/564,915

(22) PCT Filed: Jul. 20, 2004
(86) PCT No.: PCT/IB04/51258

§ 371 Date: Jan. 17, 2006

(30) Foreign Application Priority Data
Jul. 21, 2003 (EP) 03102242.9

(51) Int. Cl. G11B 7/12

(52) U.S. Cl. 369/47.53

(57) ABSTRACT

A method and an optical recording apparatus for determining the optimal write power level at a high recording speed by an OPC-procedure are described. The method involves performing an OPC-procedure at a lower recording speed and subsequently scaling the obtained results to a higher recording speed.

The invention relates to a method for setting an optimal value of a write power level of a radiation beam for use in an optical recording apparatus for writing information on an optical recording medium, the information being written on the optical recording medium by applying the radiation beam to the optical recording medium, the method comprising a first step of writing a series of test patterns in a test area on the optical recording medium, each test pattern written with a different value of the write power level of the radiation beam, a second step of reading the written test patterns to form corresponding read signal portions, and a third step of selecting the optimal value of the write power level in dependence on the read signal portions.

The invention further relates to an optical recording apparatus using the method according to the invention, and to an optical recording medium for use by the method and the apparatus according to the invention.

In optical recording a method according to the first paragraph is generally referred to as an Optimum Power Control (OPC) procedure. Such an OPC-procedure and a recording apparatus using this procedure are, for example, known from the European Patent No. EP 0737962.

In optical recording the write power level in practical recording apparatuses is normally set using such an OPC-procedure. This procedure is performed by writing a series of test patterns in a test area on the optical recording medium. This test area, commonly referred to as OPC-area, is generally located at the inner diameter of a disc shaped recording medium. In the OPC-procedure test patterns are written with various values of the write power level of the radiation beam. Subsequently, the written test patterns are read back and corresponding read signal portions are formed. By measuring, for example, the modulation and/or the asymmetry of these signal portions, each portion related to a different value of the write power level of the radiation beam, a value for the optimum write power level can be derived. OPC-procedures for various types of optical media are well known, examples of which can be found in the various standards for each of these types of media (such as for example: DVD+R 4.7 Gbytes Basic Format Specification; Format Description).

It is, however, a problem that at higher rotational speeds the OPC-procedure cannot be performed at the inner diameter of a disc anymore. It is generally believed that 160 Hz is about the maximum rotational speed of a disc shaped recording medium for reliable optical recording. When rotating a CD or DVD type disc at a rotational speed higher than this maximum rotational speed, physical deformations of the disc may occur. In case of DVD recording this roughly corresponds for the inner diameter of the disc with a 6× recording speed, that is 6 times the basic DVD speed of 3.49 m/s. So, at recording velocities above 6×, the OPC-area at the inner diameter of a disc cannot be used anymore.

In some systems an OPC-area at the outer diameter is defined. For a disc with a diameter of 120 mm a rotational speed of 160 Hz roughly corresponds for the outer diameter of the disc with a 16× recording speed. Such a system with an OPC-area at the outer diameter would therefore allow for OPC-procedures up to a recording speed of 16×. However, due to, for example, homogeneity variations the OPC results at the outer diameter are often less reliable. Furthermore, the outer part of the disc is more often contaminated with fingerprints than the inner part. Therefore, many drive designers prefer an OPC-area at the inner diameter of a disc.

A correct value of the optimum write power level is important for the recording quality, especially at the higher recording speeds where the acceptable power margins are in general smaller than at the lower speeds.

It is an object of the present invention to provide a method and an apparatus which perform an OPC-procedure at the inner diameter of a recording medium that results in reliable write power level settings at higher recording speeds.

This object is achieved according to the present invention by providing a method according to the preamble, which is characterized in that in the first step the series of test patterns are written at a low recording speed, and that in the third step the optimal value of the write power level at a high recording speed is selected in dependence on the read signal portions and on a parameter indicative of the relation between the value of the write power level at the high recording speed and the value of the write power level at the low recording speed. In this way, recordings of test patterns at the inner diameter of a disc are still performed at acceptable recording speeds, while the optimal value of the write power level at higher recording speed, at which higher recording speeds the recording of test patterns at the inner diameter of a disc is not longer reliable, can still be reliably determined.

In an embodiment it is proposed to define a parameter P_{high}/P_{low}, where P_{high} is the optimum write power level at a high recording speed and P_{low} is the optimum write power level at the OPC velocity (also referred to as Primary Velocity). In this way a drive can determine the optimum write power at the high recording speed by performing an OPC procedure at a relatively low speed at the inner diameter and by subsequently multiplying the result obtained at this low speed with the parameter P_{high}/P_{low}.

It is noted that in principle the indicative power values (P_{ind}) for the high and low velocity of the disc, as currently stored on many optical recording media, can alternatively be used. However, these values are meant to give an indication of the write power values, and the accuracy of these values is not very large. Moreover, the P_{ind} value for low velocity is given for the inner diameter OPC area, and the P_{ind} value for the high velocity is given for an outer diameter OPC area. So, again homogeneity variations in the medium may make a ratio based on the P_{ind} values less reliable.

In a further embodiment the parameter P_{high}/P_{low} is read from the recording medium itself. The parameter P_{high}/P_{low} may be stored on the recording medium in an area comprising recording parameters indicative of the recording process (including the OPC-procedure). Such an area comprising recording parameters is, for example, located in the ADIP (Address in Pre-groove).

The value for the parameter P_{high}/P_{low} as stored in the disc can be obtained very accurately during disc development or format verification, by using both velocities on one position of the disc. Furthermore, by a well-defined description of this parameter P_{high}/P_{low}, the rounding off errors can be made very small, in any case considerably smaller than when using for example the indicative power values (P_{ind}). For example:

N=200(P_{high}/P_{low}−1), where N is a digital value stored in the disc which is related to the parameter P_{high}/P_{low} would result in an accuracy of 0.5%.

These and further aspects and advantages of the invention will be discussed hereinafter with reference to the appended Figures, where

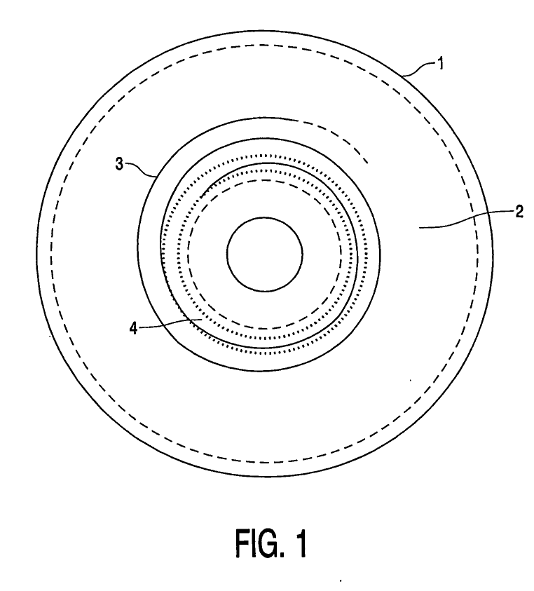

FIG. 1 shows a record carrier according to the invention,

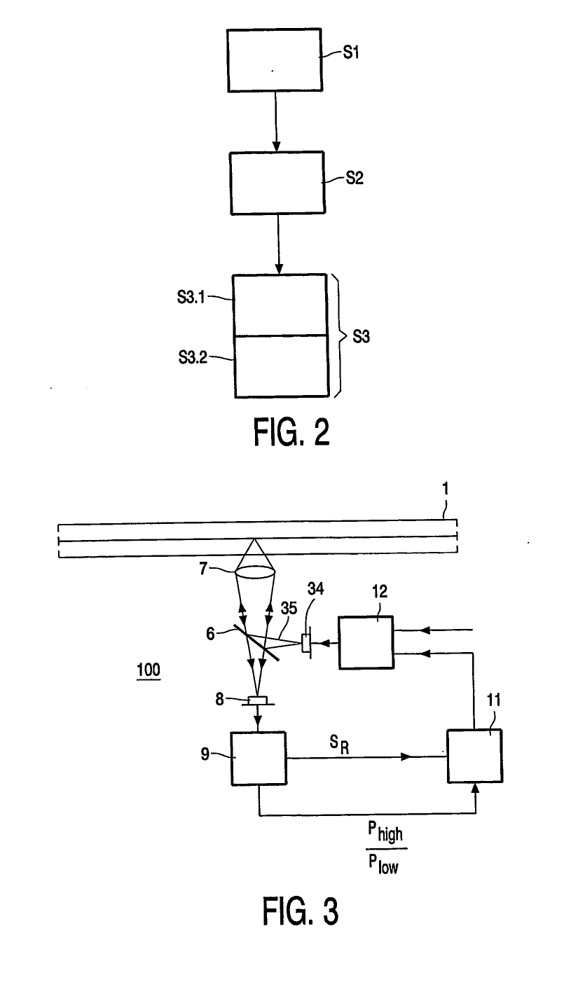

FIG. 2 shows a flow diagram of a method according to the invention, and

FIG. 3 shows a recording apparatus according to the invention.

FIG. 1 shows a disk shaped optical recording medium 1 having a diameter of 120 mm, which is the most commonly used diameter for CD and DVD type discs. The disc 1 comprises a circular area 2 having an inner diameter of 44 mm and an outer diameter of 117 mm. This area, often referred to as Information Zone, contains servo-tracks formed from a single spiral groove 3. Each servo-track forms a 360 degree turn of the continuous spiral. Information is recorded in the groove of the servo-tracks.

A test area 4 for use by an OPC-procedure is located at the inner diameter of the Information Zone 2. For example, for DVD type disks this test area 4 is referred to as Inner Disc Test Zone and is located at a radius of 22.616 mm-23.052 mm.

The servo-tracks in the Information Zone contain a phase modulated sinusoidal deviation from a nominal centerline, generally referred to as wobble. This wobble comprises addressing information called ADIP (Address in Pre-groove). Generally this ADIP contains the physical address information of a location on the disk. However in certain area's the ADIP also contains information regarding disk parameters, such as recording parameters indicative of the recording process. For example, for DVD type disks such an area, referred to as Inner Disc Identification Zone, is located in the Lead-in zone which is located at the inner diameter of the Information Zone (i.e., at a radius of 23.4 mm up to a radius of 24.0 mm). In a disk according to the invention, the information regarding disk parameters in the DAIP comprises a value for the parameter P_{high}/P_{low}, which value is predetermined for each disk.

FIG. 2 shows a flow diagram of the steps in a method according to the invention. In a first step S1 a series of test patterns is written in the test area 4 on the disk 1, each test pattern being written with a different value of the write power level of a radiation beam 35. In a second step S2 the written test patterns are read back so as to form read signal portions, each portion corresponding to a different value of the write power level. In a first portion S3.1 of a third step S3 an optimal value of the write power level is selected in dependence on the read signal portions. The above steps are well known in OPC-procedures (for example from EP 0737962).

According to the present invention the test patterns recorded in the test area 4 (in the first step S1), are being recorded at a low recording speed. Now the optimal value of the write power level determined in the first portion S3.1 of the third step S3 is valid for recording at said low recording speed.

Subsequently, the optimal value of the write power level for recording at a high recording speed is selected in a second portion S3.2 of the third step S3 in dependence on this optimal value of the write power level for recording at said low recording speed and on a parameter indicative of the relation between the value of the write power level at the high recording speed and the value of the write power level at the low recording speed. In an embodiment a parameter P_{high}/P_{low} is obtained from the ADIP on the disk (for example during disk initialization). Now, the optimal value of the write power level for recording at a high recording speed is obtained by multiplying the optimal value of the write power level for recording at said low recording speed with the parameter P_{high}/P_{low}.

FIG. 3 shows an embodiment of an optical recording apparatus according to the invention for recording information on a optical recoding medium 1, such as for example a DVD type disk. Information, for example in the form of optically detectable marks, is recorded on the recoding medium 1 by irradiation a radiation beam 35 having a write power level onto the recording medium. The apparatus comprises a radiation source 34, for example a semiconductor laser, for emitting the radiation beam 35. The radiation beam is converged onto the recording medium via a beam splitter 6 and an objective lens 7. Radiation reflected from the recording medium is converged by the objective lens and, after passing through the beam splitter, is incident on a detection system 8 which converts the incident radiation into electric detector signals. These electric detector signals are applied to a circuit 9 which derives read signal portions SR representing information being read from the recording medium from these electric detector signals. The radiation source 34, beam splitter 35, objective lens 7, detector system 8, and circuit 9 together form a read unit 100.

Under the control of a control unit 12 a series of test patterns are recorded in a test area located at the inner radius of the recording medium while recording at a low recording speed. Each test patterns is recorded with a different value of the write power level of the radiation beam 35. For example, subsequent test patterns may be recorded with a step-wise increasing write power level.

The recorded test patterns are read back by the read unit 100 so as to form the corresponding read signal portions SR These read signal portions are processed in setting means 11 to determine the optimal value of the write power level for recording at a low recording speed. Furthermore, the optimal value of the write power level for recording at a high recording speed is determined by setting means 11 by multiplying the determined optimal value of the write power level for recording at a low recording speed with a parameter P_{high}/P_{low}. This parameter P_{high}/P_{low} is read from the ADIP of the recording medium 1 by the read unit 100, and is supplied to the setting means 11. The parameter P_{high}/P_{low} is predetermined by the manufactures of the recording medium and is pre-recorded in the ADIP of the recording medium during manufacture thereof.

1. A method for setting an optimal value of a write power level of a radiation beam (35) for use in an optical recording apparatus for writing information on an optical recording medium (1), the information being written on the optical recording medium by applying the radiation beam to the optical recording medium, the method comprising a first step (S1) of writing a series of test patterns in a test area on the optical recording medium, each test pattern written with a different value of the write power level of the radiation beam, a second step (S2) of reading the written test patterns to form corresponding read signal portions, and a third step (S3) of selecting the optimal value of the write power level in dependence on the read signal portions, characterized in that
in the first step the series of test patterns are written at a low recording speed,
and that in the third step the optimal value of the write power level at a high recording speed is selected in dependence on the read signal portions and on a parameter indicative of the relation between the value of the write power level at the high recording speed and the value of the write power level at the low recording speed.

2. Method according to claim 1, wherein the parameter indicative of the relation between the value of the write power level at the high recording speed and the value of the write power level at the low recording speed (P_{high}/P_{low}) is read from the recording medium.

3. An optical recording apparatus for recording information on an optical recording medium (1) comprising a radiation source (34) for emitting a radiation beam (35) for recording information on the recording medium, the radiation beam having a controllable value of a write power level, a control unit (12) operative for recording a series of test patterns in a test area in the recording medium, each pattern with a different value of the write power level, a read unit (100) for reading the recorded test patterns and for forming corresponding read signal portions (S_{R}), and setting means (11) for setting an optimal value of the write power level in dependence on the read signal portions, characterized in that the control unit (12) is operative for recording the series of test patterns in the test area in the recording medium at a low recording speed,
and in that the setting means (11) are operative for setting an optimal value of the write power level at a high recording speed in dependence on the read signal portions and on a parameter indicative of the relation between the value of the write power level at the high recording speed and the value of the write power level at the low recording speed.

4. Apparatus according to claim 3, wherein the read unit is operative for reading the parameter indicative of the relation between the value of the write power level at the high recording speed and the value of the write power level at the low recording speed (P_{high}/P_{low}) from the recording medium.

5. Optical recording medium comprising an area comprising recording parameters indicative of the recording process, said area comprising a parameter indicative of the relation between the value of the write power level at the high recording speed and the value of the write power level at the low recording speed.

6. Optical recording medium according to claim 5, wherein the parameter is related to P_{high}/P_{low}, where P_{high} is the optimum write power level at a high recording speed and P_{low} is the optimum write power level at the OPC velocity.
